(19) United States
(12) Patent Application Publication
(10) Pub. No.: US 2013/0048321 A1
(43) Pub. Date: Feb. 28, 2013

(54) Aerating Device

(71) Applicant: Alfred Xueliang Xin, Cincinnati, OH (US)

(72) Inventor: Alfred Xueliang Xin, Cincinnati, OH (US)

(21) Appl. No.: 13/314,309

(22) Filed: Dec. 8, 2011

Related U.S. Application Data
(60) Provisional application No. 61/527,116, filed on Aug. 24, 2011.

(51) Int. Cl. A01B 45/02

(52) U.S. Cl. 172/22

(57) ABSTRACT

An aerating device that is either installed on a platform having a shoe-sole shape or any other shape has a number of hollow tines with a sharp opening at one end adapted to penetrate a lawn easily and receive soil within the hollow tine when pressed into the lawn and an opening formed on a wall of each hollow tine to release the soil from within the hollow tine. Alternatively, each hollow tine has an opening formed at an end opposite the sharp opening end to release the soil. By tying the aerating device to the operators shoes or by installing said aerating device as the sole of the operators shoe and walking along the ground, the aerating device aerates as well as releases the compacted soil on the ground.

### CROSS REFERENCE TO RELATED APPLICATIONS

The present application claims priority under 35 U.S.C. §119(e) from U.S. Provisional Patent application Ser. No. 61/527,116 filed on Aug. 24, 2011 and entitled “Aerator”, the disclosure of which is herein incorporated in its entirety.

### BACKGROUND OF THE INVENTION

1. Field of the Invention

The present invention relates generally to lawn aeration and more particularly to an aerating device.

2. Background Art

Aeration is vital in lawn maintenance, and the best way to aerate a lawn is to entail small holes in the ground to thereby allow the roots of the grasses to breathe air and absorb water efficiently and as a result improve the development of a healthier lawn.

Prior art devices and products in the market show numerous devices developed for lawn aeration, and these are categorized in to the manner in which they generate the small holes or small ditches on the ground: solid or hollow tines are either installed on devices to be operated vertically, or installed on turning wheels on devices to be operated as the wheels rotate.

Energy powered devices require large storage spaces, consume electrical or gas energy and are expensive; man-powered devices require less space to store, consume no electrical or gas energy and are inexpensive. The man-powered devices are manually pulled or pushed, or won on the feet as the operator walks across the lawn to create aeration.

While the devices worn on the feet are installed with spikes or solid tines to create holes in the ground for aeration, the spikes or solid tines push soil to the surrounding areas of the holes they created and make the soil more compact, and therefore greatly reduce the result of the operation and offset the effectiveness of the effort expended to aerate and release compacted soil.

Though there are many kinds of products for lawn aeration, there is a need for an aeration device that is inexpensive, easy to operate and store, consumes no precious energy and offers good performance with no side-affects that offset the purpose and effectiveness of the aeration operation. The aeration device preferably has means for easy penetration into the ground as well as an improved method of soil ejection.

### SUMMARY OF THE INVENTION

The inventive aerating device provides a means for aerating as well as relieving the density of compacted soil in a lawn.

A platform having a shoe sole shape or any preferred shape may be tied to the shoe of an operator, or installed directly on the sole of a shoe. The platform has a plurality of hollow tines installed thereon, each tine comprising a sharpened soil-receiving opening. The soil-receiving opening may also be beveled for easier penetration into the ground.

The wall of a each hollow tine is partially opened to release soil received through said soil receiving opening of the tine, and said open-wall portion of the tine is shaped to lead soil to be released completely. The plurality of hollow tines are installed vertically around the periphery of the platform with said open-wall portion of said hollow tines facing outwards so that soil received in the hollow tines is easily and completely released through said open-wall portion to the open area beyond the platform. In use, as the operator presses the hollow tines into the ground, soil is received within each hollow tine and then pushed out through the open-wall portion of each tine by soil received through the sharpened soil-receiving opening of each hollow tine.

In another embodiment in accordance with the invention, the plurality of hollow tines are installed vertically around the periphery of the platform such that openings in each hollow tine are disposed completely beyond the edge of the platform. Each hollow tine has a sharpened opening at one end and a flat opening at an opposite end. In use, as the operator presses the hollow tines into the ground, soil is received within each hollow tine at the sharpened opening and then pushed out through the flat opening of each tine by soil received through the sharpened soil-receiving opening of each hollow tine.

These embodiments and advantages of the invention will be set forth in part in the description which follows, and in part will be obvious from the description, or may be learned by practice of the invention. The advantages of the invention will be realized and attained by means of the elements and combinations particularly pointed out in the claims. Further it is to be understood that both the foregoing general description and the following detailed description are exemplary and explanatory only and are not limiting to the invention as claimed.

### BRIEF DESCRIPTION OF THE DRAWINGS

The present disclosure may be better understood and its numerous features and advantages made apparent to those skilled in the art by referencing the accompanying drawings wherein:

FIG. 1 is an exploded view of a hollow tine having a sharp opening on one end and a partially opened wall to relieve soil, the tip of the sharp opening being located at an opposite side of the partially opened wall of the hollow tine;

FIG. 2 is an exploded view of an embodiment of an aerator device with the hollow tines of FIG. 1 in exposed positions;

FIG. 3 is a perspective view of the embodiment of the aerator device of FIG. 2;

FIG. 4 is an exploded view of an alternative hollow tine having a sharp opening at one end and flat opening at the opposite end and an extension portion; and

FIG. 5 is an exploded view of an alternative embodiment of the aerator device having the hollow tines of FIG. 4.

### DETAILED DESCRIPTION OF THE INVENTION

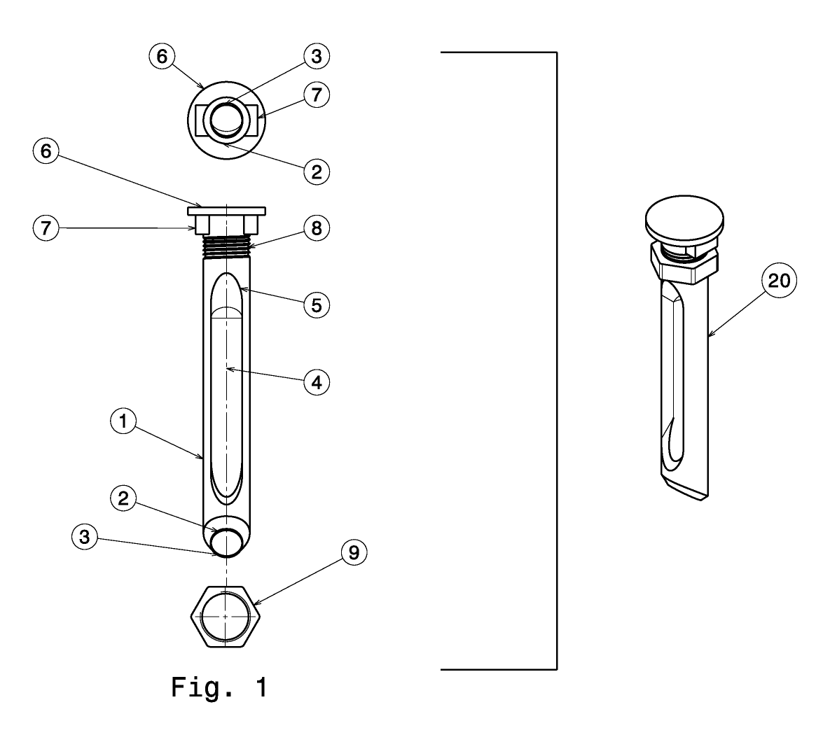

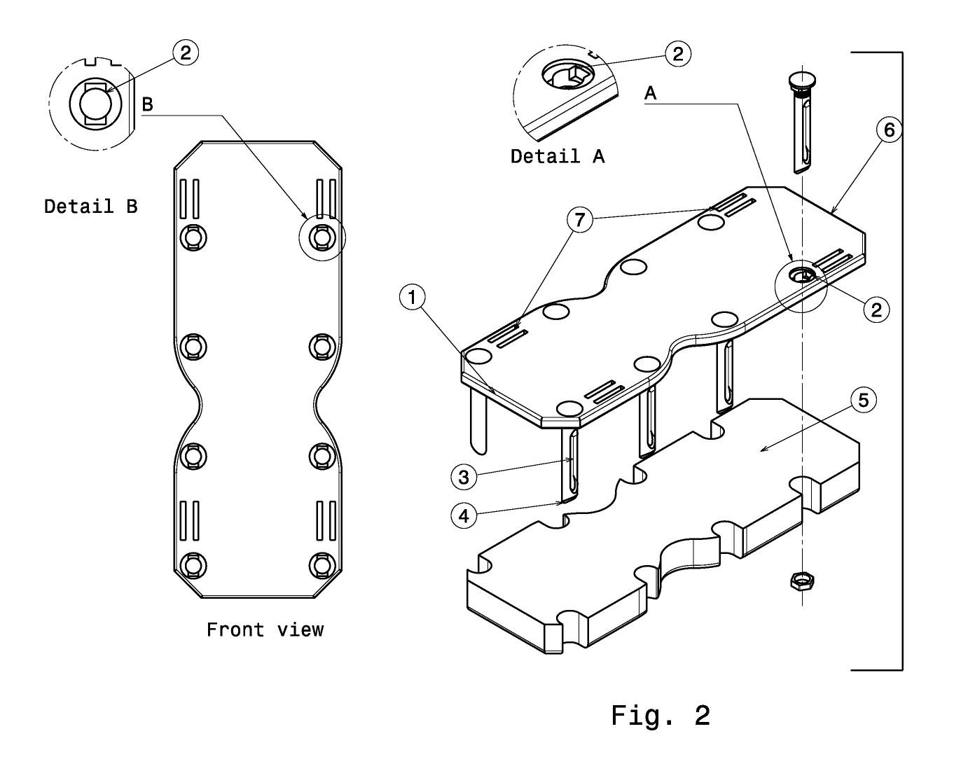

In one embodiment in accordance with the invention, and with reference to FIG. 1, a hollow tine (FIG. 1-1) includes a wall (FIG. 1-20) that is partially opened to form an open-wall portion (FIG. 1-4). The open-wall portion is shaped to expel soil (FIG. 1-5) completely from the hollow tine (FIG. 1-1). One end of the hollow tine (FIG. 1-1) has nail-head cap (FIG. 1-6), an elongated section (FIG. 1-7) for positioning-locking, and bolt threads (FIG. 1-8) for installation of said hollow tine (FIG. 1-1) on a platform (FIG. 2-1). The other end of the hollow tine (FIG. 1-1) has a beveled opening (FIG. 1-2) having a sharpened tip (FIG. 1-3) that provides for easy penetration into soil and receipt of soil within the hollow tine (FIG. 1-1). The sharpened tip (FIG. 1-3) of said opening (FIG. 1-2) is located at the opposite side of said partially open-wall portion (FIG. 1-4) of said hollow tine (FIG. 1-1). A nut (FIG. 1-9) will be applied when said hollow tine is installed to said platform.

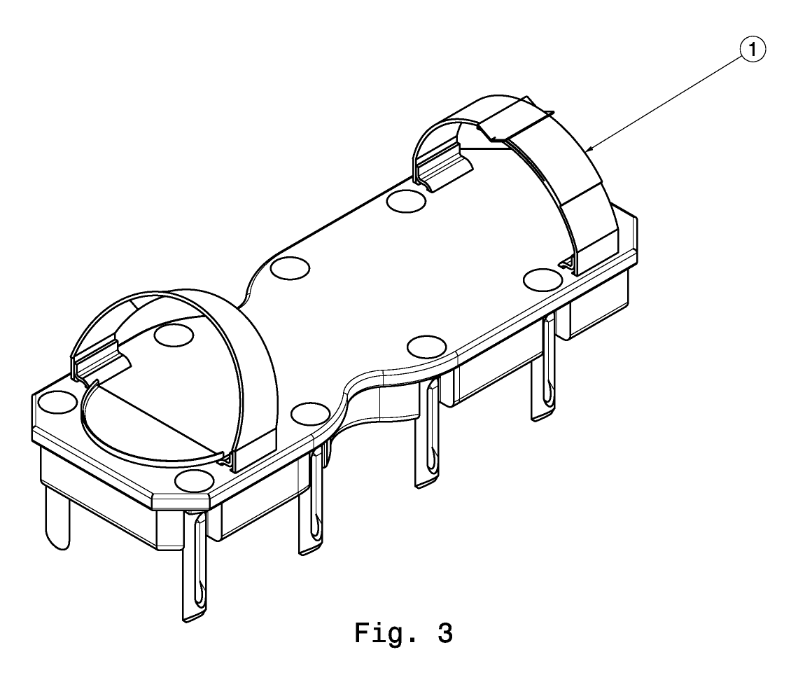

A plurality of said hollow tines (FIG. 1-1) are locked in positioning slots (FIG. 2-2) and installed with nuts (FIG. 1-9) vertically around the periphery of the platform (FIG. 2-1) having a shoe sole shape with said open-wall portion (FIG. 1-4, FIG. 2-3) of each tine (FIG. 1-1) facing outwards. Another board (FIG. 2-5) in the same shape as said platform (FIG. 2-1) and also shaped to accommodate said hollow tines (FIG. 1-1) installed on said platform (FIG. 2-1) is attached to the bottom of said platform (FIG. 2-1) by glue or bolts and nuts, so that a portion of said open-wall portion (FIG. 1-4, FIG. 2-3) is situated within the height of said platform (FIG. 2-1) and remains above the ground at all times during operation to allow the soil within said open-wall portion (FIG. 1-4, FIG. 2-3) to freely and completely be released beyond said platform (FIG. 2-1) from said open-wall portion (FIG. 1-4) on said hollow tine (FIG. 1-1) above the ground. In turn the sharpened tip (FIG. 1-3, FIG. 2-4) of the beveled opening (FIG. 1-2) faces inward from the periphery of said platform to provide safety during operation and the cleaning-up process.

The other side of said platform (FIG. 3-1) may be installed with a heel cap, belts and buckles such as those on sandals to secure said platform (FIG. 2-1) to a shoe of the operator safely.

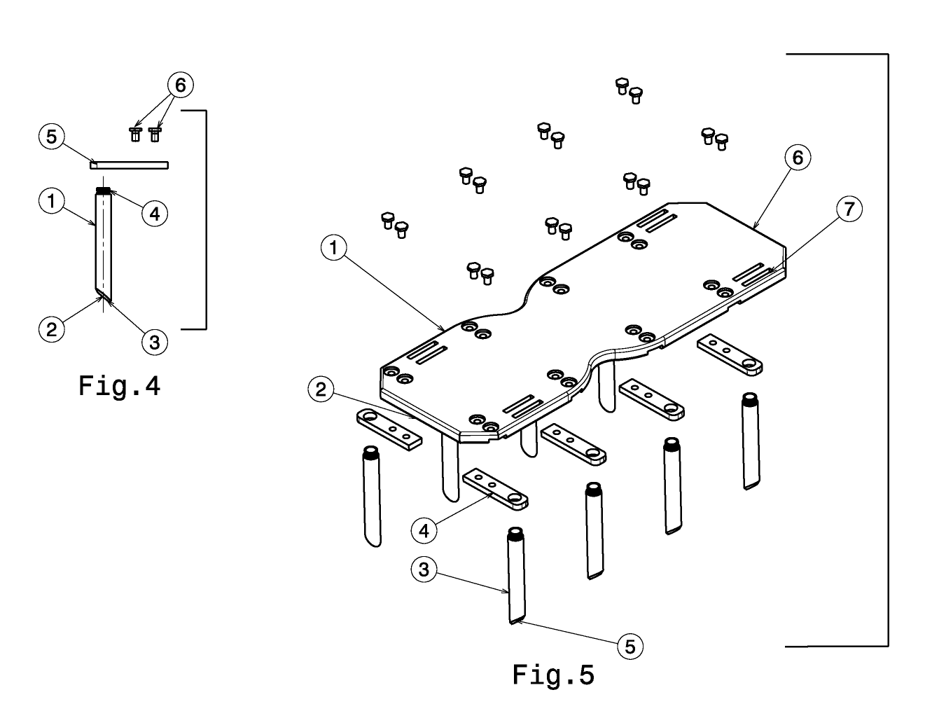

In another embodiment in accordance with the invention, the hollow tines have openings on both ends (FIG. 4-1). One end of the hollow tine (FIG. 4-1) having the bolt thread (FIG. 4-4) is installed to an extension (FIG. 4-5) with flat openings (FIG. 4-4) for bolts served for installation. The other end of said hollow tine (FIG. 4-1) has a beveled soil-receiving opening (FIG. 4-2) having a sharpened tip (FIG. 4-3) for easy penetration and receipt of soil, and the entire hollow tine (FIG. 4-1) is configured to receive soil there within.

A plurality of hollow tines (FIG. 4-1, FIG. 5-3) are installed vertically around the periphery of the platform (FIG. 5-1) such that openings (FIG. 4-2, FIG. 4-4) in each hollow tine are disposed completely beyond the edge of the platform. In use, as the operator presses the hollow tines (FIG. 4-1) into the ground, soil is received within each hollow tine at the sharpened opening (FIG. 4-2) and then pushed out through the flat opening (FIG. 4-4) of each tine by soil received through the sharpened soil-receiving opening of each hollow tine. The sharpened tip (FIG. 4-3) of the beveled opening (FIG. 4-2) faces inward (FIG. 5-5) from the periphery of the platform to provide safety during operation and the cleaning-up process.

The other side of the platform (FIG. 5-1) may be installed with heel cap, belts and buckles such as those on sandals to secure said platform to a shoe of the operator safely.

I claim:

1. An aerating device for aerating a lawn and reducing the density of compacted soil in the lawn comprising:
a platform adapted to be tied to the shoe of an operator, or installed on the sole of a shoe; and
a plurality of hollow tines installed on said platform, each of said plurality of hollow tines comprising a soil-receiving opening and a soil-relieving opening formed on a wall thereof.

2. The aerating device as claimed in claim 1, wherein said plurality of hollow tines are installed around the periphery of said platform.

3. The aerating device as claimed in claim 2, wherein the soil-relieving opening of each hollow tine faces outwards of the periphery of the platform and is positioned to completely relieve soil received through the soil-receiving opening to the open air around the periphery of said platform as an operator presses said soil-receiving opening into the ground while walking on the lawn.

4. The aerating device as claimed in claim 2, wherein said soil-receiving openings have a beveled end to easily receive soil.

5. An aerating device for aerating a lawn and reducing the density of compacted soil in the lawn comprising:
a platform adapted to be tied to the shoe of an operator; and
a plurality of hollow tines installed on said platform, each hollow tine comprising a soil-receiving opening at one end thereof and a soil-relieving opening at another end thereof.

6. The aerating device as claimed in claim 5, wherein said plurality of hollow tines are installed around the periphery of said platform.

7. The aerating device as claimed in claim 6, wherein said soil-relieving opening of each tine is positioned to completely relieve soil received through the soil-receiving opening to the open air around the periphery of said platform as the operator presses said soil-receiving opening into the ground while walking on the lawn.

8. The aerating device as claimed in claim 6, wherein said soil-receiving openings have a beveled end to easily receive soil.
